(19) United States
(12) Patent Application Publication
(10) Pub. No.: US 2022/0106232 A1
(43) Pub. Date: Apr. 7, 2022

(54) CERAMIC COMPOSITE OXIDE

(71) Applicant: CERAMIC POWDER TECHNOLOGY AS, Tiller (NO)

(72) Inventors: Guttorm SYVERTSEN-WIIG, Trondheim (NO); Sophie Beatrice LABONNOTE-WEBER, Trondheim (NO); Tor GRANDE, Trondheim (NO); Kjell WIIK, Trondheim (NO); Hilde Lea LEIN, Trondheim (NO); Mari-Ann EINARSRUD, Trondheim (NO)

(21) Appl. No.: 17/425,087

(22) PCT Filed: Jan. 27, 2020
(86) PCT No.: PCT/GB2020/050176

§ 371 Date: Jul. 22, 2021

(30) Foreign Application Priority Data
Jan. 25, 2019 (GB) 1901061.0

(51) Int. Cl. C04B 35/26; C04B 35/626; C04B 35/488; C04B 35/47; C04B 35/453

(52) U.S. Cl. CPC C04B 35/2633; C04B 2235/3274; C04B 35/4885; C04B 35/47; C04B 35/453; C04B 35/2658; C04B 2235/3213; C04B 2235/3215; C04B 2235/3225; C04B 2235/3227; C04B 2235/3229; C04B 2235/3234; C04B 2235/3248; C04B 2235/3267; C04B 35/6267

(57) ABSTRACT

The invention provides a ceramic composite oxide of formula (I): (1−x)AaBbOy+xCcDdOz (I) wherein A, B, C and D are each independently selected from the group consisting of Li, Na, Mg, Al, P, K, Ca, Sc, Ti, Cr, Mn, Fe, Co, Ni, Cu, Zn, Ga, Sr, Y, Zr, Nb, Mo, Ru, In, Sn, Ba, La, Ce, Pr, Nd, Sm, Eu, Gd, Er, Tm, Yb, Lu, Ta, W, Bi and mixtures thereof; x is 0.05 to 0.95; y and z are balanced by the charge of the cations; 0≤a, b, c, d≤1; and wherein said ceramic composite oxide has an average particle size diameter of 10 to 700 nm.

### FIELD

The present invention relates to a new process for the manufacture of ceramic composite oxide materials. The ceramic composite oxide products of the process are also encompassed by the invention, as is their use in the manufacture of electrodes, for application in devices such as, but not limited to, solid oxide fuel or electrolyzer cells, gas separation membranes, batteries and thermal barrier coatings.

### BACKGROUND

Ceramic composite oxide materials have many important applications as functional materials in electronics, catalysis and energy generation. A composite material is often preferred for various reasons including its improved mechanical strength, modified thermal expansion coefficient, combination of ionic and electrical conductivity and electrocatalytic and catalytic effect. To maximize the potential impact of a composite, the two or more phases should be mixed homogeneously, be finely distributed on a particle level, and, in many cases, small particles are beneficial. The phase intersolubility must be low to ensure thermodynamic phase separation upon heat treatment and so a finely distributed composite powder is formed, rather than a single-phase material.

Conventional ceramic composite oxides are prepared by mixing two different oxides, requiring time and energy. Alternative processes for the preparation of these materials are therefore sought.

Several studies have looked into the use of ultrasound spray pyrolysis for preparing ceramic composite oxides. These are described by, for example, Shimada et al in Journal of Power Sources, 2017, 341, 280-284 and Hagiwara et al in Solid State Ionics, 2007, 178, 1123-1134. In ultrasonic spraying methods, ultrasound is used to generate tiny droplets which are caught by a gas stream into a furnace. The liquid evaporates and leaves precipitated salts which are decomposed into oxides

Flame spray pyrolysis has also been investigated in, for example, Platinum Metals Rev., 2011, 55, (2), 149. Flame spray pyrolysis is a gas phase combustion synthesis method based on the exothermic combustion of a spray of a metallorganic liquid precursor. By means of a suitable nozzle-equipped burner, a liquid-phase mixture containing a metallorganic compound and a solvent is dispersed into a flame where the resulting mixture droplets are combusted generating small clusters. An additional oxygen flow provides both the complete combustion of the solvent and the metallorganic compound in water and CO₂.

One of the key disadvantages of both ultrasound and flame spray pyrolysis methods is the low production rate which renders their commercial use limited. The production rate of the composite oxides for these processes is in the order of grams per hour for a typical ultrasound- or flame-setup. Furthermore, ultrasonic atomisation suffers from limitations in terms of scale up and in terms of particle size control. Whilst ultrasonic atomisation might be acceptable in the laboratory, it is not practical for use in producing more than a few grams of material. There thus remains the need for the development of processes for the preparation of ceramic oxide composites which are compatible with large scale production.

The synthesis route of the present invention starts with a stable solution of cations to build up the material. To achieve a small particle size from the aqueous solution, spray pyrolysis is used to directly prepare the oxide powder. By using spray pyrolysis, a large scale preparation of high quality powder is possible. The process of the present invention can be applied to form a vast range of ceramic composite oxides.

### SUMMARY OF THE INVENTION

In a first aspect the invention provides a ceramic composite oxide of formula (I)

(1−x)AₐB_{b}O_{y}+xC_{c}D_{d}O_{z} (I)

wherein
A, B, C and D are each independently selected from the group consisting of Li, Na, Mg, Al, P, K, Ca, Sc, Ti, Cr, Mn, Fe, Co, Ni, Cu, Zn, Ga, Sr, Y, Zr, Nb, Mo, Ru, In, Sn, Ba, La, Ce, Pr, Nd, Sm, Eu, Gd, Er, Tm, Yb, Lu, Ta, W, Bi and mixtures thereof;
x is 0.05 to 0.95;
y and z are balanced by the charge of the cations;
0≤a, b, c, d≤1; and
wherein said ceramic composite oxide has an average particle size diameter of 10 to 700 nm.

In one preferable aspect, the composite ceramic oxide is of formula (Ia)

(1−x)Ba₍₁₋ₘ₎Srₘ(Zr₍₁₋ₙ₎Ceₙ)₍₁₋ₚ₎EₚO_{y}+xNiO (Ia)

wherein
E is selected from the group consisting of Y, Yb, Zn, Nd and mixtures thereof;
x is 0.2 to 0.8;
m is 0 to 1;
n is 0 to 1;
p is 0 to 0.4; and
y is balanced by the charge of the cations.

In another preferable aspect, the ceramic composite oxide is of formula (Ib)

(1−x)AₐB_{b}O_{y}+xCe_{1-d}D_{d}O_{z} (Ib)

wherein
A is selected from the group consisting of Ca, Sr, Ba, La and mixtures thereof;
B is selected from the group consisting of Cr, Mn, Fe, Co, Ni, Cu, Y, Zr, Nb, Ta, W, and mixtures thereof;
D is selected from the group consisting of La, Pr, Nd, Sm, Gd, Y, Yb, Zn;
x is 0.2 to 0.8;
y and z is balanced by the charge of the cations;
a is 0.95 to 1;
b is 1; and
d is 0 to 1.

In another aspect, the invention provides a process for the preparation of a ceramic composite oxide as hereinbefore defined, said process comprising spray pyrolysis of a solution comprising metal ions or one or both of A and B, if present, and one of both of C and D, if present, wherein spray pyrolysis is performed by atomisation of the solution into a furnace at a temperature of at least 500° C. using a dual-phase nozzle and wherein said oxide is produced at a rate of 0.5 to 10 kg/h per nozzle.

In a further aspect, the invention provides a ceramic composite oxide of formula (I) prepared by a process as hereinbefore defined.

In another aspect, the invention provides a solid oxide cell comprising a ceramic composite oxide as hereinbefore defined.

In another aspect, the invention provides the use of a ceramic composite oxide as hereinbefore defined in a solid oxide cell, preferably as an electrode or electrolyte.

In another aspect, the invention provides the use of a ceramic composite oxide as hereinbefore defined in a dense gas separation membrane.

### DETAILED DESCRIPTION

The invention relates to a ceramic composite oxide of a particular general formula and processes for the preparation thereof. The term “ceramic composite oxide” within the context of the present invention will be understood to mean a ceramic material which is a material consisting of two or more constituent ceramic materials or phases with different physical or chemical properties that, when combined, produce a material with characteristics different from the individual materials or phases. The individual materials or phases remain separate and distinct within the finished structure, differentiating composites from single phase solid solutions.

### Composite Oxides

The ceramic composite oxides of the invention are represented by formula (I)

(1−x)AₐB_{b}O_{y}+xC_{c}D_{d}O_{z} (I)

wherein
A, B, C and D are each independently selected from the group consisting of Li, Na, Mg, Al, P, K, Ca, Sc, Ti, Cr, Mn, Fe, Co, Ni, Cu, Zn, Ga, Sr, Y, Zr, Nb, Mo, Ru, In, Sn, Ba, La, Ce, Pr, Nd, Sm, Eu, Gd, Er, Tm, Yb, Lu, Ta, W, Bi and mixtures thereof;
x is 0.05 to 0.95;
y and z are balanced by the charge of the cations; and
0≤a, b, c, d≤1.

It will be understood that the composite materials of the present invention thus comprise two constituent materials, a first component denoted (1−x)AₐB_{b}O_{y} in formula (I) and a second component denoted xC_{c}D_{d}O_{z} in formula (I).

General formula (I) covers both stoichiometric and non-stoichiometric compounds.

In one embodiment, C may be Ni and d may be 0, i.e. the second component is a nickel oxide.

In one preferable embodiment, A is Zr and B is selected from the group consisting of Ce, Sm, Y, Yb, Zn, Nd and mixtures thereof.

In another preferable aspect A is Ce and B is selected from the group consisting of La, Pr, Nd, Sm, Gd, Y, Yb, Zn and mixtures thereof.

Alternatively, A may be selected from the group consisting of Ca, Sr, Ba, La, Pr, Nd, Sm, Gd, and mixtures thereof and B is selected from the group consisting of Mg, Ti, Cr, Mn, Fe, Co, Ni, Cu, Zn, Ga, Y, Nb, Mo, Yb, Ta, W and mixtures thereof.

In a further preferable embodiment, A is selected from the group consisting of Li, Na, K, Sr, Ba, Bi, and mixtures thereof, B is selected from the group consisting of Ti, Nb, Ta, Zr and mixtures thereof and x is 0.2 to 0.8.

In the aspects wherein the second component is a nickel oxide, preferable subgroups of composite oxides are represented by the following:

(1−x)Zr_{(1-b)}B_{b}O_{y}+xNiO where B is selected from the group consisting of Ce, Sm, Y, Yb, Zn, Nd and mixtures thereof; 0≤b≤1; and 0.2≤x≤0.8; and y is balanced by the charge of the cations; or
(1−x)Zr_{(1-b)}B_{b}O_{y}+xNiO where B is selected from the group consisting of Ce, Sm, Y, Yb, Zn, Nd and mixtures thereof; 0≤b≤0.1; and 0.3≤x≤0.7; and y is balanced by the charge of the cations; or
(1−x)Zr_{(1-b)}B_{b}O_{y}+xNiO, where B is selected from the group consisting of Ce, Sm, Y and mixtures thereof; 0≤b≤0.1; and 0.3≤x≤0.7; and y is balanced by the charge of the cations.
(1−x)Ce_{(1-b)}B_{b}O_{y}+xNiO, where B is selected from the group consisting of La, Pr, Nd, Sm, Gd, Y, Yb, Zn and mixtures thereof; 0≤b≤1; 0.2≤x≤0.8; and y is balanced by the charge of the cations; or
(1−x)Ce_{(1-b)}B_{b}O_{y}+xNiO, where B is selected from the group consisting of La, Pr, Nd, Sm, Gd, Y, Yb, Zn and mixtures therof; 0≤b≤0.3; and 0.2≤x≤0.8; and y is balanced by the charge of the cations; or
(1−x)Ce_{(1-b)}Gd_{b}O_{y}+xNiO, where 0≤b≤0.2; and 0.2≤x≤0.8; and y is balanced by the charge of the cations; or
(1−x)Ce_{(1-b)}Sm_{b}O_{y}+xNiO, where 0≤b≤0.2; and 0.2≤x≤0.8; and y is balanced by the charge of the cations; or
(1−x)Ce_{(1-b)}Y_{b}O_{y}+xNiO, where 0≤b≤0.2; and 0.2≤x≤0.8; and y is balanced by the charge of the cations; or
(1−x)Ce_{(1-b)}Pr_{b}O_{y}+xNiO, where 0≤b≤0.2; and 0.2≤x≤0.8; and y is balanced by the charge of the cations.
(1−x)ABO_{y}+xNiO, where A is selected from the group consisting of Ca, Sr, Ba, La, Pr, Nd, Sm, Gd and mixtures thereof; B is selected from the group consisting of Mg, Ti, Cr, Mn, Fe, Co, Ni, Cu, Zn, Ga, Y, Nb, Mo, Yb, Ta, W and mixtures thereof; 0.2≤x≤0.8; and y is balanced by the charge of the cations; or
(1−x)ABO_{y}+xNiO, A is selected from the group consisting of Sr, La and mixtures thereof; B is selected from the group consisting of Mg, Ga and mixtures thereof; 0.2≤x≤0.8; and y is balanced by the charge of the cations.
(1−x)ABO_{y}+xNiO, where A is selected from the group consisting of Li, Na, K, Sr, Ba, Bi and mixtures thereof; B is selected from the group consisting of Ti, Nb, Ta,
Zr and mixtures thereof; 0.2≤x≤0.8; and y is balanced by the charge of the cations; or
(1−x)ABO_{y}+xNiO, where A is selected from the group consisting of Na, Bi and mixtures thereof; B is selected from the group consisting of Ti, Nb, Ta, Zr and mixtures thereof; 0.2≤x≤0.8; and y is balanced by the charge of the cations; or
(1−x)ATiO_{y}+xNiO, where A is selected from the group consisting of Na, Bi or mixtures thereof; 0.2≤x≤0.8; and y is balanced by the charge of the cations.

In one particularly preferable embodiment, the ceramic composite oxide is an oxide of formula (Ia)

(1−x)Ba₍₁₋ₘ₎Srₘ(Zr₍₁₋ₙ₎Ceₙ)₍₁₋ₚ₎EₚO_{y}+xNiO (Ia)

wherein
E is selected from the group consisting of Y, Yb, Zn, Nd and mixtures thereof;
x is 0.2 to 0.8;
y is balanced by the charge of the cations;
m is 0 to 1;
n is 0 to 1;
p is 0 to 0.4; or
(1−x)Ba(Zr₍₁₋ₙ)Ceₙ)₍₁₋ₚ₎EₚO_{y}+xNiO, where E is selected from the group consisting of Y, Yb and mixtures thereof; 0≤n≤1; 0≤p≤0.3; 0.2≤x≤0.8 and y is balanced by the charge of the cations.
Other preferable subgroups of composite oxides include the following:
An oxide of formula (Ib)

(1−x)AₐB_{b}O_{y}+xCe_{1-d}D_{d}O_{z} (Ib)

wherein
A is selected from the group consisting of Ca, Sr, Ba, La and mixtures thereof;
B is selected from the group consisting of Cr, Mn, Fe, Co, Ni, Cu, Y, Zr, Nb, Ta, W and mixtures thereof;
D is selected from the group consisting of La, Pr, Nd, Sm, Gd, Y, Yb, Zn;
x is 0.2 to 0.8;
y and z are balanced by the charge of the cations;
a is 0.95 to 1;
b is 1; and
d is 0 to 1.
In formula (Ib), it is preferred if D is Gd.
In one embodiment, for formula (Ib), A may be a mixture of Sr and La.
In another embodiment for formula (Ib), B may be a mixture of Fe and Co.
(1−x)AₐBO_{y}+xCe_{(1-d)}D_{d}O_{z}, where A is selected from the group consisting of Ca, Sr, La and mixtures thereof; B is selected from the group consisting of Cr, Mn, Fe, Co, Ni, Cu and mixtures thereof; D is selected from the group consisting of Pr, Sm, Gd and mixtures thereof; 0.95≤a≤1; 0≤d≤1; 0.3≤x≤0.7; and y and z are balanced by the charge of the cations; or
(1−x)AₐBO_{y}+xCe_{(1-d)}Gd_{d}O_{z}, where A is selected from the group consisting of Ca, Sr, La and mixtures thereof; B is selected from the group consisting of Cr, Mn, Fe, Co and mixtures thereof; 0.95≤a≤1; 0≤d≤1; 0.3≤x≤0.7; and y and z are balanced by the charge of the cations; or
(1−x)AₐBO_{y}+xCe_{(1-d})Sm_{d}O_{z}, where A is selected from the group consisting of Ca, Sr, La and mixtures thereof; B is selected from the group consisting of Cr, Mn, Fe, Co and mixtures thereof; 0.95≤a≤1; 0≤d≤1; 0.2≤x≤0.8; and y and z are balanced by the charge of the cations; or
(1−x)AₐBO_{y}+xCe_{(1-d})Pr_{d}O_{z}, where A is selected from the group consisting of Ca, Sr, La and mixtures thereof; B is selected from the group consisting of Cr, Mn, Fe, Co and mixtures thereof; 0.95≤a≤1; 0≤d≤1; 0.2≤x≤0.8; and y and z are balanced by the charge of the cations; or
(1−x)AₐBO_{y}+xCe_{(1-d)}Y_{d}O_{z}, where A is selected from the group consisting of Ca, Sr, La and mixtures thereof; B is selected from the group consisting of Cr, Mn, Fe, Co and mixtures thereof; 0.95≤a≤1; 0≤d≤1; 0.2≤x≤0.8; and y and z are balanced by the charge of the cations.
(1−x)AₐBO_{y}+xZr_{(1-d)}D_{d}O_{z}, where A is selected from the group consisting of Ca, Sr, Ba, La and mixtures thereof; B is selected from the group consisting of Cr, Mn, Fe, Co, Ni, Cu, Y, Zr, Nb, Ta, W and mixtures thereof; D is selected from the group consisting of Ce, Sm, Y, Yb, Zn, Nd and mixtures thereof; 0.95≤a≤1; 0≤d≤1; 0.2≤x≤0.8; and y and z are balanced by the charge of the cations; or
(131 x)AₐBO_{y}+xZr_{(1-d)}D_{d}O_{z}, where A is selected from the group consisting of Ca, Sr, La and mixtures thereof; B is selected from the group consisting of Cr, Mn, Fe, Co, Ni, Cu and mixtures thereof; D is selected from the group consisting of Ce, Sm, Y and mixtures thereof; 0.95≤a≤1; 0≤d≤1; 0.2≤x≤0.8; and y and z are balanced by the charge of the cations.
(1−x)AₐBO_{y}+xCDO_{z}, where A is selected from the group consisting of Ca, Sr, Ba, La and mixtures thereof; B is selected from the group consisting of Cr, Mn, Fe, Co, Ni, Cu, Y, Zr, Nb, Ta, W and mixtures thereof; C is selected from the group consisting of Ca, Sr, Ba, La, Pr, Nd, Sm, Gd and mixtures thereof; D is selected from the group consisting of Mg, Ti, Cr, Mn, Fe, Co, Ni, Cu, Zn, Ga, Y, Nb, Mo, Yb, Ta, W and mixtures thereof; 0.95≤a≤1; 0.2≤x≤0.8; and y and z are balanced by the charge of the cations; or
(1−x)AₐBO_{y}+xCDO_{z}, where A is selected from the group consisting of Ca, Sr, La and mixtures thereof; B is selected from the group consisting of Cr, Mn, Fe, Co, Ni,

Cu and mixtures thereof; C is selected from the group consisting of Sr, Ca, La and mixtures thereof; D is selected from the group consisting of Mg, Ga and mixtures thereof; 0.95≤a≤1; 0.2≤x≤0.8; and y and z are balanced by the charge of the cations.

(1−x)AₐBO_{y}+xCDO_{z}, where A is selected from the group consisting of Ca, Sr, Ba, La and mixtures thereof; B is selected from the group consisting of Cr, Mn, Fe, Co, Ni, Cu, Y, Zr, Nb, Ta, W and mixtures thereof; C is selected from the group consisting of Li, Na, K, Sr, Ba, Bi and mixtures thereof; D is selected from the group consisting of Ti, Nb, Ta, Zr and mixtures thereof; 0.95≤a≤1; 0.2≤x≤0.8; and y and z are balanced by the charge of the cations; or
(1−x)AₐBO_{y}+xCDO_{z}, where A is selected from the group consisting of Ca, Sr, La and mixtures thereof; B is selected from the group consisting of Cr, Mn, Fe, Co, Ni, Cu and mixtures thereof; C is selected from the group consisting of Li, Na, K, Sr, Ba, Bi and mixtures thereof; D is selected from the group consisting of Ti, Nb, Ta, Zr and mixtures thereof; 0.95≤a≤1; 0.2≤x≤0.8; and y and z are balanced by the charge of the cations; or
(1−x)AₐBO_{y} +xCDO_{z}, where A is selected from the group consisting of Ca, Sr, La and mixtures thereof; B is selected from the group consisting of Cr, Mn, Fe, Co, Ni, Cu and mixtures thereof; C is selected from the group consisting of Na, Ba, Bi and mixtures thereof; D is selected from the group consisting of Ti, Nb, Ta, Zr and mixtures thereof; 0.95≤a≤1; 0.2≤x≤0.8; and y and z are balanced by the charge of the cations.
(1−x)AₐBO_{y} +xCe_{(1-d)}D_{d}O_{z}, where A is selected from the group consisting of Sr, Ca, Ba, La, Ce, Pr, Nd, Sm, Gd and mixtures thereof; B is selected from the group consisting of Ti, Cr, Mn, Fe, Co, Ni, Cu, Zn, Nb, Ta, W and mixtures thereof; D is selected from the group consisting of La, Pr, Nd, Sm, Gd, Y, Yb, Zn and mixtures thereof; 0.75≤a≤1; 0≤d≤1; 0.2≤x≤0.8; and y and z are balanced by the charge of the cations; or
(1−x)AₐBO_{y}+xCe_{(1-d)}D_{d}O_{z}, where A is selected from the group consisting of Sr, Ca,

La and mixtures thereof; B is selected from the group consisting of Ti, Cr, Mn, Fe, Co, Ni, Cu and mixtures thereof; D is selected from the group consisting of La, Pr, Nd, Sm, Gd, Y, Yb, Zn and mixtures thereof; 0.75≤a≤1; 0≤d≤0.2; 0.2≤x≤0.8; and y and z are balanced by the charge of the cations; or

(1−x)AₐBO_{y}+xCe_{(1-d)}Gd_{d}O_{z}, where A is selected from the group consisting of Sr,

Ca, La and mixtures thereof; B is selected from the group consisting of Ti, Cr, Mn, Fe, Co, Ni, Cu and mixtures thereof; 0.75≤a≤1; 0≤d≤0.2; 0.2≤x≤0.8; and y and z are balanced by the charge of the cations; or

(1−x)AₐBO_{y}+xCe_{(1-d)}Sm_{d}O_{z}, where A is selected from the group consisting of Sr, Ca, La and mixtures thereof; B is selected from the group consisting of Ti, Cr, Mn, Fe, Co, Ni, Cu and mixtures thereof; 0.75≤a≤1; 0≤d≤0.2; 0.2≤x≤0.8; and y and z are balanced by the charge of the cations; or
(1−x)AₐBO_{y}+xCe_{(1-d)}Pr_{d}O_{z}, where A is selected from the group consisting of Sr, Ca, La and mixtures thereof; B is selected from the group consisting of Ti, Cr, Mn, Fe, Co, Ni, Cu and mixtures thereof; 0.75≤a≤1; 0≤d≤0.2; 0.2≤x≤0.8; and y and z are balanced by the charge of the cations; or
(1−x)AₐBO_{y}+xCe_{(1-d)}Y_{d}O_{z}, where A is selected from the group consisting of Sr, Ca, La and mixtures thereof; B is selected from the group consisting of Ti, Cr, Mn, Fe, Co, Ni, Cu and mixtures thereof; 0.75≤a≤1; 0≤d≤0.2; 0.2≤x≤0.8 and y and z are balanced by the charge of the cations.
(1−x)AₐBO_{y}+xZr_{(1-d)}d_{d}O_{z}, where A is selected from the group consisting of Sr, Ca, Ba, La, Ce, Pr, Nd, Sm, Gd and mixtures thereof; B is selected from the group consisting of Ti, Cr, Mn, Fe, Co, Ni, Cu, Zn, Nb, Ta, W and mixtures thereof; D is selected from the group consisting of Ce, Sm, Y, Yb, Zn, Nd and mixtures thereof; 0.75≤a≤1; 0≤d≤1; 0.2≤x≤0.8; and y and z are balanced by the charge of the cations; or
(1−x)AₐBO_{y}+xZr_{(1-d)}D_{d}O_{z}, where A is selected from the group consisting of Sr, Ca, La and mixtures thereof; B is selected from the group consisting of Ti, Cr, Mn, Fe, Co, Ni, Cu and mixtures thereof; D is selected from the group consisting of Ce, Sm, Y and mixtures thereof; 0.75≤a≤1; 0≤d≤1; 0.2≤x≤0.8; and y and z are balanced by the charge of the cations.
(1−x)ABO_{y}+xC_{c}DO_{z}, where A is selected from the group consisting of of Ca, Sr, Ba, La, Pr, Nd, Sm, Gd and mixtures thereof; B is selected from the group consisting of Mg, Ti, Cr, Mn, Fe, Co, Ni, Cu, Zn, Ga, Y, Nb, Mo, Yb, Ta, W and mixtures thereof; C is selected from the group consisting of Sr, Ca, Ba, La, Ce, Pr, Nd, Sm, Gd and mixtures thereof; D is selected from the group consisting of Ti, Cr, Mn, Fe, Co, Ni, Cu, Zn, Nb, Ta, W and mixtures therof; 0.75≤c≤1; 0.2≤x≤0.8; and y and z are balanced by the charge of the cations; or
(1−x)ABO_{y}+xCeDO_{z}, where A is selected from the group consisting of Sr, Ca, La and mixtures thereof; B is selected from the group consisting of Mg, Ga and mixtures thereof; C is selected from the group consisting of Sr, Ca, La and mixtures thereof; D is selected from the group consisting of Ti, Cr, Mn, Fe, Co, Ni, Cu and mixtures thereof; 0.75≤c≤1; 0.2≤x≤0.8; and y and z are balanced by the charge of the cations.
(1−x)Ba₍₁₋ₘ₎Srₘ(Zr₍₁₋ₙ₎Ceₙ)₍₁₋ₚ₎EₚO_{y}xC_{c}DO_{z}, where A is selected from the group consisting of Ca, Sr, Ba, La and mixtures thereof; B is selected from the group consisting of Cr, Mn, Fe, Co, Ni, Cu, Y, Zr, Nb, Ta, W and mixtures thereof; D is selected from the group consisting of Y, Yb, Zn, Nd and mixtures therof; 0.95≤c≤1; 0≤m≤1; 0≤n<1; 0≤p≤0.4; 0.2≤x≤0.8; and y and z are balanced by the charge of the cations; or
(1−x)Ba₍₁₋ₘ₎Srₘ(Zr₍₁₋ₙ₎Ceₙ)₍₁₋ₚ₎EₚO_{y}xC_{c}DO_{z}, where A is selected from the group consisting Ca, Sr, Ba, La and mixtures thereof; B is selected from the group consisting Cr, Mn, Fe, Co, Ni, Cu, Y, Zr and mixtures thereof; D is selected from the group consisting Y, Yb and mixtures thereof; 0.95≤c≤1; 0≤m≤1; 0≤n≤1; 0≤p≤0.4; 0.2≤x≤0.8; and y and z are balanced by the charge of the cations; or
(1−x)Ba(Zr₍₁₋ₙ₎)Ceₙ)₍₁₋ₚ₎EₚO_{y}+xC_{c}DO_{z}, where A is selected from the group consisting Ca, Sr, Ba, La and mixtures thereof; B is selected from the group consisting of Cr, Mn, Fe, Co, Ni, Cu, Y, Zr and mixtures thereof; D is selected from the group consisting Y, Yb and mixtures thereof; 0.95≤c≤1; 0≤n≤1; 0≤p≤0.4; 0.2≤x≤0.8; and y and z are balanced by the charge of the cations.
(1−x)LiBO_{y}+xLiD_{d}O_{z}, where B and D are selected from the group consisting of Ti, Cr, Mn, Fe, Co, Ni, Cu, Zn and mixtures thereof; 0.1≤x≤0.9; 1≤d≤2; and y and z are balanced by the charge of the cations.
(1−x)LiBO_{y}+xLiDPO_{z}, where B and D are selected from the group consisting of Ti, Cr, Mn, Fe, Co, Ni, Cu, Zn and mixtures thereof; 0.1≤x≤0.9; and y and z are balanced by the charge of the cations.
(1−x)LiB_{b}O_{y}+xLiDPO_{z}, where B and D are selected from the group consisting of Ti, Cr, Mn, Fe, Co, Ni, Cu, Zn and mixtures thereof; 0.1≤x≤0.9; 1≤b≤2; and y and z are balanced by the charge of the cations.
(1−x)LiBO_{y}+xLi_{c}D_{d}O_{z}, where B is selected from the group consisting of Ti, Cr, Mn, Fe, Co, Ni, Cu, Zn and mixtures thereof; D is selected from the group consisting of Li, Al, Mg, Ca, Sc, Ti, Ga, Sr, Y, Zr, Nb, Ba, La, Ta, W and mixtures thereof; 1≤c≤7; 4≤d≤6; 0.1≤x≤0.9; and y and z are balanced by the charge of the cations.
(1−x)LiB_{b}O_{y}+xLi_{c}D_{d}O_{z}, where B is selected from the group consisting of Ti, Cr, Mn, Fe, Co, Ni, Cu, Zn and mixtures thereof; D is selected from the group consisting of Li, Al, Mg, Ca, Sc, Ti, Ga, Sr, Y, Zr, Nb, Ba, La, Ta, W and mixtures thereof; 0.1≤x≤0.9; 1≤b≤2; 1≤c≤7; 4≤d≤6; and y and z are balanced by the charge of the cations.
(1−x)LiCPO_{y}+xLi_{c}D_{d}O_{z}, where C is selected from the group consisting of Ti, Cr, Mn, Fe, Co, Ni, Cu, Zn and mixtures thereof; D is selected from the group consisting of Li, Al, Mg, Ca, Sc, Ti, Ga, Sr, Y, Zr, Nb, Ba, La, Ta, W and mixtures thereof; 1≤c≤7; 4≤d≤6; 0.1≤x≤0.9; and y and z are balanced by the charge of the cations.
(1−x)LiBO_{y}+xCDO_{z}, where B is selected from the group consisting of Ti, Cr, Mn, Fe, Co, Ni, Cu, Zn and mixtures thereof; C is selected from the group consisting of Li, La, Sr and mixtures thereof; D is selected from the group consisting of Ti, Sn, Zr, Mn, Fe, Co, Ni, Nb, Ta and mixtures thereof; 0.1≤x≤0.9; and y and z are balanced by the charge of the cations.
(1−x)LiB_{b}O_{y}+xCDO_{z}, where B selected from the group consisting of Ti, Cr, Mn, Fe, Co, Ni, Cu, Zn and mixtures thereof; C is selected from the group consisting of Li, La, Sr and mixtures thereof; D is selected from the group consisting of Ti, Sn, Zr, Mn, Fe, Co, Ni, Nb, Ta and mixtures thereof; 0.1≤x≤0.9; 1≤b≤2; and y and z are balanced by the charge of the cations.
(1−x)LiBPO_{y}+CDO_{z}, where B is selected from the group consisting of Ti, Cr, Mn, Fe, Co, Ni, Cu, Zn and mixtures thereof; C is selected from the group consisting of Li, La, Sr and mixtures thereof; D is selected from the group consisting of Ti, Sn, Zr, Mn, Fe, Co, Ni, Nb, Ta and mixtures thereof; 0.1≤x≤0.9; and y and z are balanced by the charge of the cations.
(1−x)ABO_{y}+xZr_{(1-d)}D_{d}O_{z}, where A is selected from the group consisting of La, Gd, Sm, Nd, Eu, Yb and mixtures thereof; B is selected from the group consisting of Zr, Ce,Hf and mixtures thereof; D is selected from the group consisting of Ce, Mg, Sc, Y, In, Ca, Nd, Gd, Sm, Yb and mixtures thereof; 0≤d≤1; and 0.2≤x≤0.8; and y and z are balanced by the charge of the cations.
(1−x)AₐO_{y}+xZr_{(1-d)}D_{d}O_{z}, where A is Al; D is selected from the group consisting of Ce, Mg, Sc, Y, In, Ca, Nd, Gd, Sm, Yb and mixtures thereof; a=2; 0≤d≤1; 0.2≤x≤0.8; and y and z are balanced by the charge of the cations.

The ceramic composite oxides of the invention have an average particle size diameter in the range of 10 to 700 nm. In preferable embodiments, the particle size diameter is 15 to 600 nm, such as 20 to 500 nm. The particle sizes quoted herein represent average particle size. Particle sizes may be measured by surface area or by electron microscopy studies.

The specific surface area of the particles of the ceramic composite oxides of the invention is typically in the range 0.5 to 100 m²/g, especially 1 to 50 m²/g, e.g. 2-30 m²/g.

It is preferred if the first component denoted (1−x)AₐB_{b}O_{y} in formula (I) and the second component denoted xC_{c}D_{d}O_{z} in formula (I) are thermodynamically and/or kinetically co-stable at temperatures below 900° C.

In one particularly preferred embodiment, the ceramic composite oxide is not 30 wt % La_{0.6}Sr_{0.4}Co_{0.2}Fe_{0.8}O_{3-δ}+70 wt % Ce_{0.9}Gd_{0.1}O_{2-δ.}

The ceramic composite oxide as defined herein preferably comprises the first component denoted (1−x)AₐB_{b}O_{y} in an amount of 10 to 90 wt % and the second component denoted xC_{c}D_{d}O_{z} in an amount of 90 to 10 wt %, relative to the total weight of the composite oxide as a whole. More preferable wt % ranges for the first component are 20 to 80 wt %, especially 30 to 70 wt %, such as 40 to 60 wt % e.g. 50 wt %. More preferable wt % ranges for the second component are 80 to 20 wt %, especially 70 to 30 wt %, such as 60 to 40 wt %, e.g. 50 wt %.

### Process

The invention also relates to processes for the preparation of ceramic composite oxides as hereinbefore defined.

The process of the invention involves the spray pyrolysis of a solution containing all the metal ions required to form the desired compound of formula (I). The invention relies therefore on the formation of a solution of the metal ions necessary to form the ceramic composite oxide of formula (I). It is therefore necessary to provide soluble metal salts of each reactant metal ion.

For any metal ion, any convenient metal salt can be used if it is soluble. Preferred metal salts are nitrates, alkoxides, carboxylates, ketonates, oxalates and/or dioxalates, and salts of organic acids, especially acetates. Particularly preferred are nitrates.

The solution required can be prepared by dissolving salts in the solvent simultaneously or sequentially or could involve the preparation of one or more precursor solutions containing one or more of the reactant metal ions. The skilled man can devise ways of making the solution required.

Soluble metal salts can be prepared using any convenient counter ion (e.g. a nitrate, chloride, sulphate and so on) or using one or more complexing agents with appropriate solvent. Suitable complexing agents could be hexadentate, pentadentate, tetradentate, tridentate or bidentate ligands, in particular amino polycarboxylic acid chelating agents. Suitable ligands include EDTA, cyclohexanediamine tetraacetic acid (CDTA), citric acid, malic acid, maleic acid, DOTA, DTPA and ethylene diamine.

Preferably the solution is an aqueous solution, i.e. comprising water (e.g. distilled water). The skilled man will appreciate that metal salts are generally readily soluble so all manner of salts can be used here although it is essential that any counter ion/complexing agent used with a metal ion does not form insoluble salts or other precipitate with any other metal ion present.

Alternatively, precursor solutions of one or more of the metal ions may be employed. The precursor solutions use water as solvent. Preferably water alone, especially distilled water is employed.

The molarity of any metal ion solutions used in the processes of the invention is preferably in the range of 0.01 M to 5 M. Stirring, sonication or other mixing techniques can be used to ensure homogeneity. Preferably mixing of the metal salt and water takes place over a period of at least 6 hours. It is also preferred if during this stirring process the temperature is elevated slightly, e.g. up to 80° C. or higher if the vessel is pressurized.

The metal ions can then be mixed in an appropriate ratio (e.g. depending on the molarity of each solution used and the desired stoichiometry of the final product) and the solution which forms can be spray pyrolysed. Stirring, sonication or other mixing techniques can again be used to ensure homogeneity of the solution prior to or during spray pyrolysis. Preferably mixing takes place over a period of at least 6 hours.

It is highly preferred if the solvent used throughout the manufacturing process comprises water (e.g. comprises at least 80 wt %, such as at least 90 wt % water). Most preferably the solvent consists of water.

The pressure at the nozzle in the spray pyrolysis process may be in the range 1 to 3 bars. This may be achieved using a nozzle 0.5 to 5 mm, preferably 1 to 2 mm in diameter. The atomising gas can be any gas which is inert to the reactant materials, including air.

Atomisation occurs into a furnace at temperatures of at least 500° C. Ideally, the temperature is in the range 700 to 1200° C., preferably 800 to 1000° C.

In a particularly preferred embodiment, the processes of the invention do not comprise the use of ultrasound at the nozzle.

The powder which exits the furnace (e.g. at a temperature of approximately 400 to 550° C.) can be collected by a filter or a cyclone.

The particles of this invention can be formed without any deposition surface. We do not need to spray pyrolyse onto a surface to induce particle formation rather, our particles form due to evaporation of the solvents from the atomized droplets, preferably formed by the dual-phase nozzle described below. Deposition is in fact a potential problem as it can lead to scraping of the formed particles from the deposition surface and hence contamination. Deposition onto a surface also leads to the formation of a layer of material on that surface, i.e. to the formation of a film. The present invention primarily concerns the formation of distinguishable particles and not a thin film on a substrate. It is preferred to collect particles in a cyclone thus creating a free flowing powder and not a film.

It is therefore preferred if the particles form a free flowing powder. The formation of a free flowing powder directly after spray pyrolysis is a further preferred feature of the invention. It is thus a feature of the invention that the particles formed directly after spray pyrolysis preferably do not adhere to any surface.

In particular, it is preferred if the soft agglomerates formed at this stage of the process have a particle size distribution which conforms to D(v, 0.5) of 1 to 40 μm and a value of the ratio of D(v, 0.9)-D(v, 0.1) to D(v, 0.5) of no more than 3. Preferably, the D(v, 0.5) value is 1 to 20 μm. These values are achieved directly after spray pyrolysis and prior to subsequent processing steps.

Controlling particle size is an important aspect of the invention. In order to achieve the best control, the spray pyrolysis method of the invention preferably employs a dual phase nozzle arrangement to ensure atomisation, narrow particle size distribution and high yields. In this arrangement, the particle precursor materials are provided in the form of an emulsion or solution which is atomised in a dual phase nozzle and flows into a hot zone such as a furnace. In the hot zone each droplet is converted to a particle and any solvent/emulsion components etc are decomposed into gas. Particle size can be controlled by e.g. varying droplet size. Droplet size is in turn controlled by manipulation of the nozzle outlet. Langmuir 2009, 25, 3402-3406 contains a description of the use of flame spray pyrolysis in the manufacture of yttrium oxide particles and provides the skilled man with details of this known process. Other factors which could control particle size include the temperatures employed in the process and the concentration of the metal ions in the starting solution.

In particular, in the pyrolysis process, mixing means, for producing a flow mixture of solution, e.g. aqueous solution, and air, is combined with an atomizing nozzle to provide a nozzle assembly which produces a jet of very fine droplets. The nozzle assembly is used in conjunction with a hot zone such as a furnace. The mixing means comprises a pipe, external of the hot zone having separate, spaced inlets for the solution and air. A reducing diameter nozzle is positioned in the pipe bore between the inlets, for accelerating the air.

The air contacts the solution and turbulently moves down the pipe bore to produce what is known as a “bubbly flow” mixture. The mixture is fed to the nozzle, which is inside of the hot zone. The nozzle has an inlet; a first contraction section of reducing diameter for accelerating the flow, preferably to supersonic velocity, whereby the droplets are reduced in size; a diffuser section of expanding diameter wherein the mixture decelerates and a shock wave may be induced; a second contraction section operative to accelerate the mixture more than the first contraction section; and an orifice outlet for producing a jet or spray. The nozzle assembly is designed to give droplets in the region of 1 to 10 μm.

The use of a dual phase nozzle arrangement will be familiar to the skilled man.

Whilst the powder formed after the spray pyrolysis step could be used directly, the product of the spray pyrolysis reaction normally contains minor amounts of non-combusted organic material and traces of anions from the salt that is not decomposed which can be removed by calcination (e.g. at 400 to 1200° C., preferably 550 to 1000° C., e.g. about 600 to 800° C.). During calcination the powder is usually exposed to high temperature for a period of 1 to 24 hours, preferably 4 to 12 hours. It has been found that the final crystallite size can be controlled by the temperature at which calcination takes place, lower temperatures being associated with smaller crystallite sizes. During the process of the invention, the primary particles or crystallites can aggregate to form soft agglomerates. Prior to calcination these agglomerates are often of the order of less than 20 microns and hence still represent a free flowing powder. Post calcination the agglomerates have broken down into smaller aggregates of the primary particles, preferably in the range 10 to 700 nm, especially 20 to 500 nm in diameter.

The calcination step also improves the crystallinity of the formed powder. It is a preferable feature of the invention therefore that the prepared oxide is a crystalline solid.

Again, the product formed after calcination and optional milling can be used directly. Viewed from another aspect the invention provides a ceramic composite oxide obtained by the spray pyrolysis process as hereinbefore defined and after calcination.

It is also possible however for the powder formed after calcination to be milled, typically wet milled to reduce its volume. This is not essential; however, milling ensures a more consistent particle size distribution by breaking down any remaining agglomerates into the primary particles or crystallites. Any suitable type of milling method can be used, such as jet milling or ball milling. Milling can also be effected in the presence of water, ethanol, isopropanol, acetone or other solvent. Yttria-stabilised zirconia is a typical grinding medium. Milling can also be effected by impacting particles by a jet of compressed air or any inert gas.

The process of the invention produces the ceramic composite oxide at a rate per nozzle of 0.5 to 10 kg/h, preferably 1 to 5 kg/h.

### Applications

The ceramic composite oxides of the invention may be employed in a range of applications where such composites are known to be suitable materials. In particular, the composites of the invention may be used in a solid oxide fuel or electrolyzer cell, including both fuel cells and electrolyser cells.

Thus, in a further embodiment, the invention provides the use of a ceramic composite oxide as hereinbefore defined as an electrode or an electrolyte in a solid oxide cell, preferably an electrode.

The invention also relates to a solid oxide cell comprising a ceramic composite oxide as hereinbefore defined. Preferably, the solid oxide cell is a solid oxide fuel cell or a solid oxide electrolyser cell. In a preferred embodiment, the solid oxide cell comprises the ceramic composite oxide as an electrode or electrolyte, more preferably as an electrode.

The invention also relates to a dense gas separation membrane comprising a ceramic composite oxide as hereinbefore defined. In a preferred embodiment, the membrane comprises the ceramic composite oxide.

Other potential applications include electronics such as lead-free electroceramics and piezoceramics, catalysts including photocatalysts, thermal barrier coatings, gas-separation membranes, solid state batteries and lithium-ion batteries.

The invention will now be described further with reference to the following non-limiting examples and figures.

### BRIEF DESCRIPTION OF THE FIGURES

FIG. 1: Schematic diagram of spray pyrolysis method

FIG. 2: Schematic diagram of particle structure at various stages of production process

FIG. 3: X-ray diffractogram of 30 wt % La_{0.6}Sr_{0.4}Co_{0.2}Fe_{0.8}O_{3-δ}+70 wt % Ce_{0.9}Gd_{0.1}O_{2-δ} (CGO-LSCF)

FIG. 4: X-ray diffractogram of 50 vol % Sr_{0.9}La_{0.1}TiO_{3-δ}+50 vol % Ce_{0.9}Gd_{0.1}O_{2-δ} (SLT-CGO)

FIG. 5: X-ray diffractogram of BaZr_{0.85}Y_{0.15}O_{3-δ}+NiO; 40 wt % NiO (BZY-NiO-1)

FIG. 6: X-ray diffractogram of 40 wt % BaCe_{0.7}Zr_{0.2}Y_{0.1}O_{3-δ}+60 wt % NiO (BCZY-NiO)

FIG. 7: Particle size distribution of 40 wt % BaCe_{0.7}Zr_{0.2}Y_{0.1}O_{3-δ}+60 wt % NiO (BCZY-NiO)

FIG. 8: Area specific resistance of 30 wt % La_{0.6}Sr_{0.4}Co_{0.2}Fe_{0.8}O_{3-δ}+70 wt % Ce_{0.9}Gd_{0.1}O_{2-δ} (CGO-LSCF).

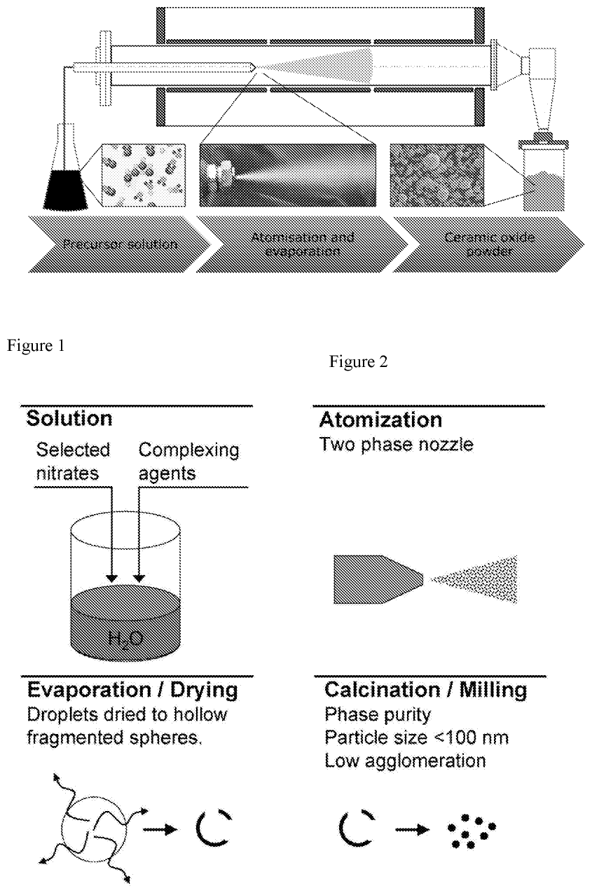

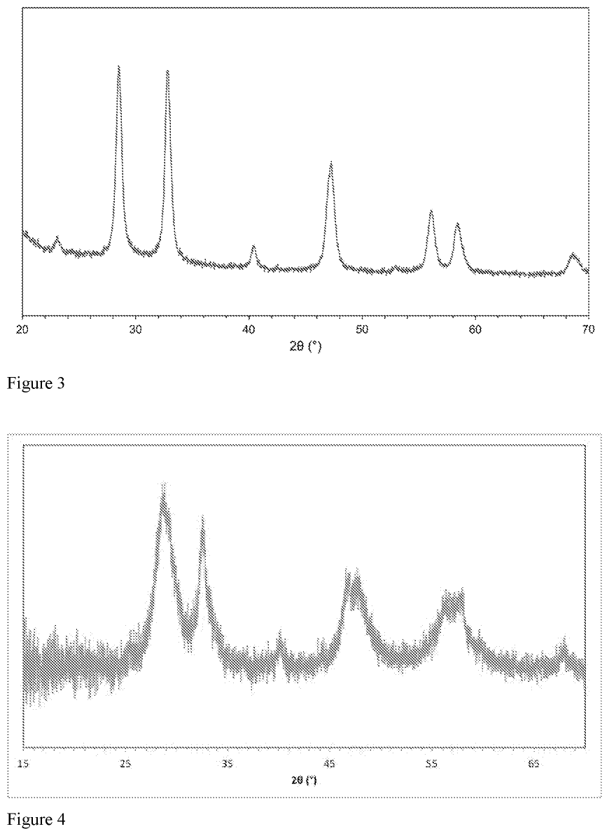

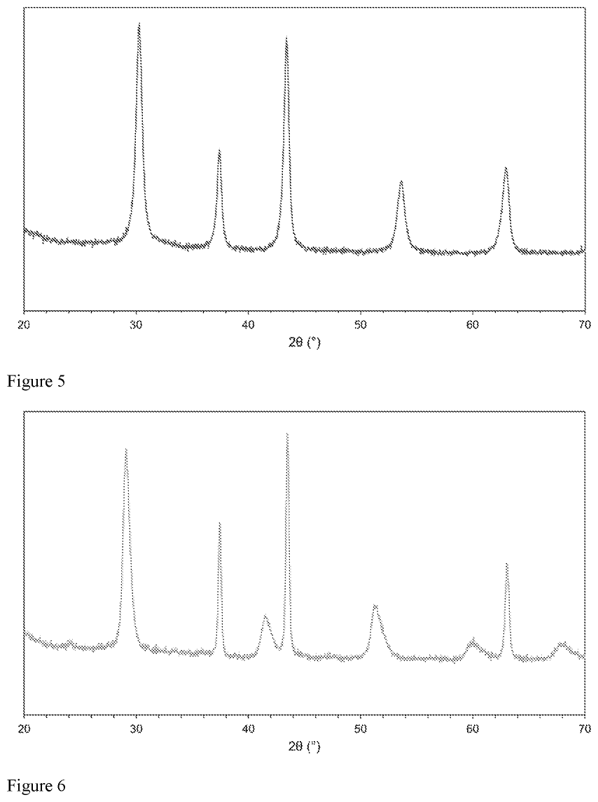

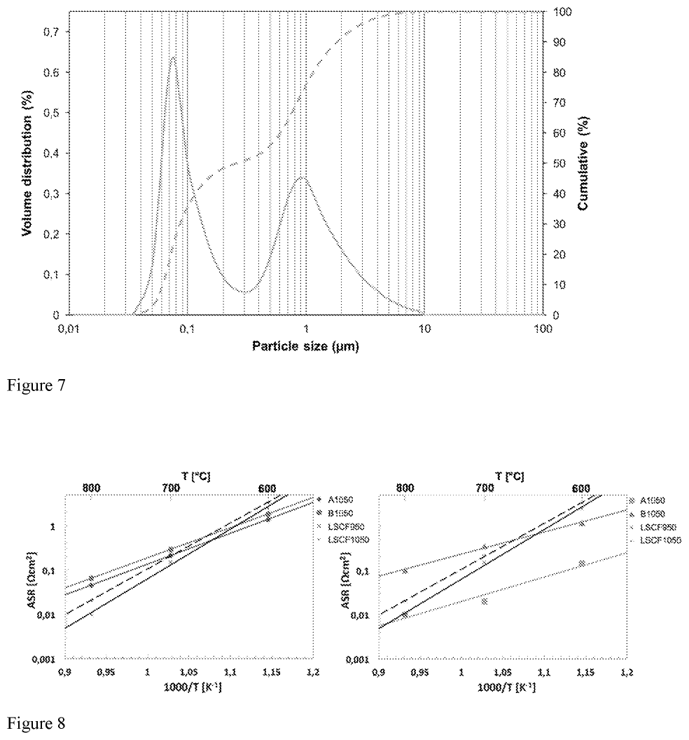

Samples A950 and A1050 are co-sprayed cer-cer composites, while B950 and B1050 are composites of the same phases prepared by mixing the two oxides.

LSCF950 and LSCF1050 are single phase cathodes of LSCF for comparison. “950” and “1050” mean the sample was heat treated at 950° C. and 1050° C., respectively.

### EXAMPLES

### Test Methods

X-Ray Diffraction

Powder X-ray diffractograms were obtained from 15 to 70° with step size of 0.0275° and 0.5 s counting time with a Bruker D2 Phaser, equipped with a Lynxeye detector and Ni- and Cu-filters using CuKa radiation accelerated at 40 kV and 40 mA.

Particle Size Distribution

Powder was dispersed in an isopropanol solution containing 2 wt % oxide powder and 5 wt % ethyl cellulose relative to the solid content. The instrument used was Horiba LA-960 Laser Particle Size Analyzer equipped with both red (655 nm) and blue (405 nm) lasers measuring 10 000 points for each wavelength and refractive index of 2.15/0.4i.

Area Specific Resistance

Electrochemical impedance spectroscopy was performed on symmetric cells using a tubular furnace with a ProboStat sample holder setup for circular samples. An Alpha-A High Performance Frequency Analyzer from Novocontrol was used to analyze the impedance response. The measurements were done in dry air atmosphere. The amplitude of the applied AC signal was 50 mV for the first sample. For the following samples, the amplitude was adjusted to 700 mV due to noise in the measurements. The frequency investigated ranged from 1 MHz to 1 mHz. The symmetrical cells were prepared by spraying dispersions of 5 wt % powder in 92 wt % ethanol and 3 wt % dolacol using an air-brush connected to an argon gas outlet with excess pressure of 0.5 bar. The cells were sintered at 950° C. or 1050° C. for 6 hours with heating and cooling rates of 200° C./h

### Example 1

### Preparation of 30 wt % La_{0.6}Sr_{0.4}Co_{0.2}Fe_{0.8}O_{3-δ}+70 wt % Ce_{0.9}Gd_{0.1}O_{2-δ} (CGO-LSCF-1)

La(NO₃)₃x6H₂O (2 M), Co(NO₃)₂x6H₂O (2 M) with EDTA, Fe(NO₃)₂x6H₂O (2 M) with EDTA, Ce(NO₃)₃x6H₂O (4M) and Gd(NO₃)₃x6H₂O (2 M) were dissolved in distilled water to prepare cation precursor solutions. Each solution was thermogravimetrically analysed to determine the exact concentrations and the solutions mixed into one together with Sr(NO₃)₂ crystals according to the stoichiometric ratio in the formula. The solution was fed into a water-cooled lance at a rate of 100 ml/min and atomised in a nozzle with aid of pressurised air at 2 bar. The droplets were transported through the hot zone in a furnace tube, at a set temperature of 1000° C., by an underpressurised air stream where the time of flight inside the furnace tube was less than one second. The air stream was led into a cyclone where the powder was separated and collected. The collected powder consisted of hollow spheres (agglomerates) with, depending on precursor solution concentration, temperature, feeding rate, air pressure, air velocity and organic additives, diameter 1-20 μm, and primary particles around 100 nm. The powder was further heat treated at 650° C. for 6 hours to achieve phase purity and decompose any organic residue. To break down the hollow spheres, the powder was milled for 24 hours by wet ball milling using 5 mm yttria-stabilised zirconia and ethanol, followed by drying and sieving.

Other ceramic composite oxides in accordance with the invention can be prepared by this process using any of the chelating agents herein described, or any combination of such chelating agents, to solubilise any of the metal ions.

### Example 2

### Preparation of 50 wt % La_{0.6}Sr_{0.4}Co_{0.2}Fe_{0.8}O_{3-δ}+50 wt % Ce_{0.9}Gd_{0.1}O_{2-δ} (CGO-LSCF-2)

La(NO₃)₃x6H₂O (2 M), Co(NO₃)₂x6H₂O (2 M), Fe(NO₃)₂x6H₂O (2 M), Ce(NO₃)₃x6H₂O (4M) and Gd(NO₃)₃x6H₂O (2 M) were dissolved in distilled water to prepare cation precursor solutions. Each solution was thermogravimetrically analysed to determine the exact concentrations and the solutions mixed into one together with Sr(NO₃)₂ crystals according to the stoichiometric ratio in the formula. The solution was fed into a water-cooled lance at a rate of 100 ml/min and atomised in a nozzle with aid of pressurised air at 2 bar. The droplets were transported through the hot zone in a furnace tube, at a set temperature of 1000° C., by an underpressurised air stream where the time of flight inside the furnace tube was less than one second. The air stream was led into a cyclone where the powder was separated and collected. The collected powder consisted of hollow spheres (agglomerates) with, depending on precursor solution concentration, temperature, feeding rate, air pressure, air velocity and organic additives, diameter 1-20 μm, and primary particles around 100 nm. The powder was further heat treated at 800° C. for 6 hours to achieve phase purity and decompose any organic residue. To break down the hollow spheres, the powder was milled for 24 hours by wet ball milling using 5 mm yttria-stabilised zirconia and isopropanol, followed by drying and sieving.

### Example 3: Preparation of 50 vol % Sr_{0.9}La_{0.1}TiO_{3-δ}+50 vol % Ce_{0.5}Gd_{0.1}O_{2-δ} (SLT-CGO)

La(NO₃)₃x6H₂O (2 M), Ce(NO₃)₃x6H₂O (4M) and Gd(NO₃)₃x6H₂O (2 M) were dissolved in distilled water in molar concentrations ˜2-4 M to prepare cation precursor solutions. Titanium isopropoxide was mixed with water and citric acid and boiled to decompose the isopropoxide forming a clear solution. Each solution was thermogravimetrically analysed to determine the exact concentrations and the solutions mixed into one together with Sr(NO₃)₂ crystals according to the stoichiometric ratio in the formula. The solution was fed into a water-cooled lance at a rate of 100 ml/min and atomised in a nozzle with aid of pressurised air at 2 bar. The droplets were transported through the hot zone in a furnace tube, at a set temperature of 1000° C., by an underpressurised air stream where the time of flight inside the furnace tube was less than one second. The air stream was led into a cyclone where the powder was separated and collected. The collected powder consisted of hollow spheres (agglomerates) with, depending on precursor solution concentration, temperature, feeding rate, air pressure, air velocity and organic additives, diameter 1-20 μm, and primary particles around 100 nm. The powder was further heat treated at 600° C. for 6 hours to achieve phase purity and decompose any organic residue. To break down the hollow spheres, the powder was milled for 48 hours by wet ball milling using 10 mm yttria-stabilised zirconia and isopropanol, followed by drying and sieving.

Other ceramic composite oxides in accordance with the invention can be prepared by this process using any of the chelating agents herein described, or any combination of such chelating agents, to solubilise any of the metal ions.

### Example 4: Preparation of BaZr_{0.85}Y_{0.15}O_{3-δ}+NiO; 40 wt % NiO (BZY-NiO-1)

Ba(NO₃)₂ (0.5 M) with complexing agents, Y(NO₃)₃x6H₂O (2.5 M) and Ni(NO₃)₂x6H₂O (1 M) were dissolved in distilled water to prepare cation precursor solutions. ZrO(NO₃)₃x6H₂O was mixed with water and citric acid and heated to form a clear solution. Each solution was thermogravimetrically analysed to determine the exact concentrations and the solutions mixed into one according to the stoichiometric ratio in the formula. The solution was fed into a water-cooled lance at a rate of 160 ml/min and atomised in a nozzle with aid of pressurised air at 2 bar. The droplets were transported through the hot zone in a furnace tube, at a set temperature of 1000° C., by an underpressurised air stream where the time of flight inside the furnace tube was less than one second. The air stream was led into a cyclone where the powder was separated and collected. The collected powder consisted of hollow spheres (agglomerates) with, depending on precursor solution concentration, temperature, feeding rate, air pressure, air velocity and organic additives, diameter 1-20 μm, and primary particles around 100 nm. The powder was further heat treated at 950° C. for 6 hours to achieve phase purity and decompose any organic residue. To break down the hollow spheres, the powder was milled for 48 hours by wet ball milling using 10 mm yttria-stabilised zirconia and isopropanol, followed by drying and sieving.

In this example, the complexing agents can be selected from any of the chelating agents herein described, or any combination of such chelating agents.

### Example 5: Preparation of 40 vol % BaZr_{0.85}Y_{0.15}O_{3-δ}+60 vol % NiO (BZY-NiO-2)

Ba(NO₃)₂ (0.5 M) with complexing agents, Y(NO₃)₃x6H₂O (2.5 M) and Ni(NO₃)₂x6H₂O (1 M) were dissolved in distilled water to prepare cation precursor solutions. ZrO(NO₃)₃x6H₂O was mixed with water and citric acid and heated to form a clear solution. Each solution was thermogravimetrically analysed to determine the exact concentrations and the solutions mixed into one according to the stoichiometric ratio in the formula. The solution was fed into a water-cooled lance at a rate of 160 ml/min and atomised in a nozzle with aid of pressurised air at 2 bar. The droplets were transported through the hot zone in a furnace tube, at a set temperature of 1000° C., by an underpressurised air stream where the time of flight inside the furnace tube was less than one second. The air stream was led into a cyclone where the powder was separated and collected. The collected powder consisted of hollow spheres (agglomerates) with, depending on precursor solution concentration, temperature, feeding rate, air pressure, air velocity and organic additives, diameter 1-20 μm, and primary particles around 100 nm. The powder was further heat treated at 900° C. for 6 hours to achieve phase purity and decompose any organic residue. To break down the hollow spheres, the powder was milled for 48 hours by wet ball milling using 10 mm yttria-stabilised zirconia and isopropanol, followed by drying and sieving.

In this example, the complexing agents can be selected from any of the chelating agents herein described, or any combination of such chelating agents.

### Example 6: Preparation of 40 wt % BaCe_{0.7}Zr_{0.2}Y_{0.1}O_{3-δ}+60 wt % NiO (BCZY-NiO)

Ba(NO₃)₂ (0.5 M) with complexing agents, Ce(NO₃)₃x6H₂O (4M), Y(NO₃)₃x6H₂O (2.5 M) and Ni(NO₃)₂x6H₂O (1 M) were dissolved in distilled water to prepare cation precursor solutions. ZrO(NO₃)₃x6H₂O was mixed with water and citric acid and heated to form a clear solution. Each solution was thermogravimetrically analysed to determine the exact concentrations and the solutions mixed into one according to the stoichiometric ratio in the formula. The solution was fed into a water-cooled lance at a rate of 160 ml/min and atomised in a nozzle with aid of pressurised air at 2 bar. The droplets were transported through the hot zone in a furnace tube, at a set temperature of 1000° C., by an underpressurised air stream where the time of flight inside the furnace tube was less than one second. The air stream was led into a cyclone where the powder was separated and collected. The collected powder consisted of hollow spheres (agglomerates) with, depending on precursor solution concentration, temperature, feeding rate, air pressure, air velocity and organic additives, diameter 1-20 μm, and primary particles around 100 nm. The powder was further heat treated at 1100° C. for 6 hours to achieve phase purity and decompose any organic residue. To break down the hollow spheres, the powder was milled for 48 hours by wet ball milling using 10 mm yttria-stabilised zirconia and isopropanol, followed by drying and sieving.

In this example, the complexing agents can be selected from any of the chelating agents herein described, or any combination of such chelating agents.

### Example 7: 50 wt % Li_{6.25}Al_{0.25}La₃Zr₂O₁₂+50 wt % LiCoO₂ (LALZ-LCO)

La(NO₃)₃x6H₂O (1 M), LiNO₃ (2.5 M), Co(NO₃)₂x6H₂O (1 M), ZrO(NO₃)₃x6H₂O and Al(NO₃)₃x9H₂O (1 M) were dissolved in distilled water and complexing agents to prepare cation precursor solutions. Each solution was thermogravimetrically analysed to determine the exact concentrations and the solutions mixed into one according to the stoichiometric ratio in the formula. The Li solution was added with 0-30% Li excess. The precursor solution was spray pyrolyzed as described in Example 1 and the resulting green powder was treated in a similar manner to produce the ceramic composite oxide. The complexing agents may be selected from any of the chelating agents herein described, or any combination of such chelating agents.

### Example 8: 85 wt % La_{0.67}Ca_{0.33}MnO₃+15 wt % Sm₂O₃ (LCM-SmO)

La(NO₃)₃x6H₂O (0.5 M) with complexing agents, Mn(NO₃)₂x4H₂O (2.5 M), Ca(NO₃)₂x4H₂O (0.5 M) and Sm(NO₃)₃x6H₂O (1 M) were dissolved in distilled water to prepare cation precursor solutions. Each solution was thermogravimetrically analysed to determine the exact concentrations and the solutions mixed into one according to the stoichiometric ratio in the formula. The precursor solution was spray pyrolyzed as described in Example 1 and the resulting green powder was treated in a similar manner to produce the ceramic composite oxide. The complexing agents may be selected from any of the chelating agents herein described, or any combination of such chelating agents.

### Example 9: 80 wt % La_{0.7}Sr_{0.3}MnO₃+20 wt % ZnO (LSM-ZnO)

La(NO₃)₃x6H₂O (1 M) with complexing agents, Mn(NO₃)₂x4H₂O (2.5 M) and Zn(NO₃)₂x6H₂O (1 M) were dissolved in distilled water to prepare cation precursor solutions. Each solution was thermogravimetrically analysed to determine the exact concentrations and the solutions mixed into one together with Sr(NO₃)₂ crystals according to the stoichiometric ratio in the formula. The precursor solution was spray pyrolyzed as described in Example 1 and the resulting green powder treated in a similar manner to produce the ceramic composite oxide. The complexing agents may be selected from any of the chelating agents herein described, or any combination of such chelating agents.

### Example 10: 86 wt % 0.93Ba_{0.5}Na_{0.5}TiO₃-0.07BaTiO₃+14 wt % ZnO (BNT-BT-ZnO)

Ba(NO₃)₂ (0.25 M) with complexing agents, titanium isopropoxide, C₁₂H₂₈O₄Ti (1 M) with complexing agents, bismuth citrate, C₆H₅BiO₇ (0.5 M) with complexing agents, NaNO₃ (2 M) and Zn(NO₃)₂x6H₂O (0.5 M) were dissolved in distilled water to prepare cation precursor solutions. Each solution was thermogravimetrically analysed to determine the exact concentrations and the solutions mixed into one according to the stoichiometric ratio in the formula. The precursor solution was spray pyrolyzed as described in Example 1 and the resulting green powder was treated in a similar manner to produce the ceramic composite oxide. The complexing agents may be selected from any of the chelating agents herein described, or any combination of such chelating agents.

### Example 11: 50 wt % Pr_{0.4}Sr_{0.6}(Co_{0.2}Fe_{0.8})_{0.9}Mo_{0.1}O_{3-δ}+50 wt % Ce_{0.9}Gd_{0.1}O_{2-δ} (PSCFM-CGO)

(NH₄)₆Mo₇O₂₄x4H₂O (0.1 M) with complexing agents, Co(NO₃)₂x6H₂O (0.5 M) with complexing agents, Fe(NO₃)₂x6H₂O (0.5 M) with complexing agents, Ce(NO₃)₃x6H₂O (0.5M) with complexing agents, Pr(NO₃)₃x6H₂O (0.5 M) with complexing agents and Gd(NO₃)₃x6H₂O (0.5 M) were dissolved in distilled water to prepare cation precursor solutions. Each solution was thermogravimetrically analysed to determine the exact concentrations and the solutions mixed into one together with Sr(NO₃)₂ crystals according to the stoichiometric ratio in the formula. The precursor solution was spray pyrolyzed as described in Example 1 and the resulting green powder treated in a similar manner to produce the ceramic composite oxide. The complexing agents may be selected from any of the chelating agents herein described, or any combination of such chelating agents.

1. A ceramic composite oxide of formula (I):
(1−x)AₐB_{b}O_{y}+xC_{c}D_{d}O_{z} (I)
wherein
A, B, C and D are each independently selected from the group consisting of Li, Na, Mg, Al, P, K, Ca, Sc, Ti, Cr, Mn, Fe, Co, Ni, Cu, Zn, Ga, Sr, Y, Zr, Nb, Mo, Ru, In, Sn, Ba, La, Ce, Pr, Nd, Sm, Eu, Gd, Er, Tm, Yb, Lu, Ta, W, Bi, and mixtures thereof;
x is 0.05 to 0.95;
y and z are balanced by the charge of the cations;
0≤a, b, c, d≤1; and
wherein the ceramic composite oxide has an average particle size diameter of 10 to 700 nm.

2. The ceramic composite oxide of claim 1, wherein C is Ni and d is 0.

3. The ceramic composite oxide of claim 1, wherein A is Zr and B is selected from the group consisting of Ce, Sm, Y, Yb, Zn, Nd, and mixtures thereof.

4. The ceramic composite oxide of claim 1, wherein A is Ce and B is selected from the group consisting of La, Pr, Nd, Sm, Gd, Y, Yb, Zn and mixtures thereof.

5. The ceramic composite oxide of claim 1, wherein A is selected from the group consisting of Ca, Sr, Ba, La, Pr, Nd, Sm, Gd, and mixtures thereof; and B is selected from the group consisting of Mg, Ti, Cr, Mn, Fe, Co, Ni, Cu, Zn, Ga, Y, Nb, Mo, Yb, Ta, and mixtures thereof.

6. The ceramic oxide composite of claim 1, wherein A is selected from the group consisting of Li, Na, K, Sr, Ba, Bu, and mixtures thereof; B is selected from the group consisting of Ti, Nb, Ta, Zr and mixtures thereof; and x is 0.2 to 0.8.

7. The ceramic composite oxide of claim 1, wherein the ceramic composite oxide is of formula (Ia):
(1−x)Ba₍₁₋ₘ₎Srₘ(Zr₍₁₋ₙ₎Ceₙ)₍₁₋ₚ₎EₚO_{y}+xNiO (Ia)
wherein
E is selected from the group consisting of Y, Yb, Zn, Nd, and mixtures thereof;
x is 0.2 to 0.8;
y is balanced by the charge of the cations;
m is 0 to 1;
n is 0 to 1; and
p is 0 to 0.4.

8. The ceramic composite oxide of claim 1, wherein the ceramic composite oxide is of formula (Ib):
(1−x)AₐB_{b}O_{y}+xCe_{1-d}D_{d}O (Ib)
wherein
A is selected from the group consisting of Ca, Sr, Ba, La, and mixtures thereof;
B is selected from the group consisting of Cr, Mn, Fe, Co, Ni, Cu, Y, Zr, Nb, Ta, W, and mixtures thereof;
D is selected from the group consisting of La, Pr, Nd, Sm, Gd, Y, Yb, and Zn;
x is 0.2 to 0.8;
y is balanced by the charge of the cations;
a is 0.95 to 1;
b is 1; and
d is 0 to 1.

9. The ceramic composite oxide of claim 8, wherein D is Gd.

10. The ceramic composite oxide of claim 8, wherein A is a mixture of Sr and La.

11. The ceramic composite oxide of claim 8, wherein B is a mixture of Fe and Co.

12. The ceramic composite oxide of claim 1, wherein the first component denoted (1−x)AₐB_{b}O_{y} is present in an amount of 10 to 90 wt %; and the second component denoted xC_{c}D_{d}O_{z} is present in an amount of 90 to 10 wt %, relative to the total weight of the ceramic composite oxide as a whole.

13. A process for the preparation of the ceramic composite oxide of claim 1, the process comprising:
spray pyrolysis of a solution comprising metal ions of one or both of A and B, when present, and one of both of C and D, when present,
wherein the spray pyrolysis comprises atomizing the solution into a furnace at a temperature of at least 500° C. using a dual-phase nozzle, and
wherein the ceramic composite oxide is produced at a rate of 0.5 to 10 kg/h per nozzle.

14. The process of claim 13, wherein the solution is an aqueous solution.

15. The process of claim 14, wherein the aqueous solution is prepared from water soluble precursors comprising at least one metal nitrate.

16. The process of claim 13, wherein the spray pyrolysis produces a fine powder product and the process further comprises: collecting the fine powder product by cyclone; and calcining the fine powder product at a temperature in the range of 400-1200° C., thereby forming calcined, spray pyrolyzed particles.

17. The process of claim 16, wherein the calcination is carried out at a temperature of 550 to 800° C.

18. The process of claim 16, further comprising: forming the calcined, spray pyrolyzed particles into a green body; and sintering the green body.

19. The process of claim 16, further comprising: milling of the fine powder product after calcination.

20. (canceled)

21. A solid oxide cell comprising the ceramic composite oxide of claim 1.

22. A method of use of the ceramic composite oxide of claim 1, the method comprising using the ceramic composite oxide as an electrode or electrolyte in a solid oxide cell.

23. A method of use of the ceramic composite oxide of claim 1, the method comprising using the ceramic composite oxide in a dense gas separation membrane.
